(19) United States
(12) Patent Application Publication
(10) Pub. No.: US 2016/0046420 A1
(43) Pub. Date: Feb. 18, 2016

(54) SPORTS WATER BOTTLE

(71) Applicant: SIENNA GROUP CORPORATION, TAICHUNG CITY (TW)

(72) Inventor: CHEN-KUEI WU, TAICHUNG CITY (TW)

(21) Appl. No.: 14/460,403

(22) Filed: Aug. 15, 2014

(51) Int. Cl. B65D 47/24; B62J 11/00; B65D 23/10; B65D 23/12; A47G 19/22; B65D 23/06

(52) U.S. Cl. CPC B65D 47/243; A47G 19/2266; B65D 23/06; B65D 23/102; B65D 23/12; B62J 11/00

(57) ABSTRACT

A sports water bottle includes a bottle body and a water stopper. The bottle body has a liquid inlet. The liquid inlet has a wall edge portion. The water stopper is disposed on top of the wall edge portion of the liquid inlet, and has a plurality of elastic valves. The water stopper has a retraction position and an expansion position to open and close the liquid inlet, respectively. The water stopper is normally located at the retraction position. When the water stopper is applied with an external force to push the water stopper, the water stopper is changed from the retraction position to the expansion position for infusing liquid into the bottle body. When not applied with the external force, the water stopper is changed from the expansion position to the retraction position.

### BACKGROUND OF THE INVENTION

1. Field of the Invention

The present invention relates to a sports water bottle having a pluggable liquid inlet which is beneficial for infusing liquid quickly during riding and lowing the probability of water seepage.

2. Description of the Prior Art

A conventional water bottle for an auxiliary handle of a bike is usually provided with a cover for infusing water into the water bottle. However, the conventional device is a single piece structure. The water may spill easily.

In addition, riding a bike takes quite physical energy. So far, there is no design for a bike water bottle provided with a stopwatch, a supplement, and a storage rack. Accordingly, the inventor of the present invention has devoted himself based on his many years of practical experiences to solve these problems.

### SUMMARY OF THE INVENTION

The primary object of the present invention is to provide a sports water bottle having a pluggable liquid inlet which is beneficial for infusing liquid quickly during riding and lowing the probability of water seepage.

To achieve the aforesaid object, the sports water bottle of the present invention includes a bottle body and a water stopper. The bottle body has an accommodation space, a liquid inlet, and a liquid outlet. The liquid inlet has a wall edge portion. The water stopper is disposed on top of the wall edge portion of the liquid inlet, and has a plurality of elastic valves corresponding to the wall edge portion. The water stopper has a retraction position and an expansion position to open and close the liquid inlet, respectively. The water stopper is normally located at the retraction position.

When the water stopper is applied with an external force to push the water stopper, the water stopper is changed from the retraction position to the expansion position for infusing liquid into the bottle body through the liquid inlet of the bottle body. When not applied with the external force, the water stopper is changed from the expansion position to the retraction position.

### BRIEF DESCRIPTION OF THE DRAWINGS

FIG. 1 is a perspective view of the present invention;

FIG. 2 is a partial exploded view of FIG. 1;

FIG. 3 is a perspective view of FIG. 2;

FIG. 4 is a sectional view of FIG. 3;

FIG. 5 is a schematic view showing the water stopper before the water bottle is inserted;

FIG. 6 is a schematic view showing the water stopper after the water bottle is inserted;

FIG. 7 is a partial enlarged view of FIG. 6;

FIG. 8 is an exploded view of the present invention applied to a bike handle;

FIG. 8-A is an enlarged view showing the elastic valve of the water stopper;

FIG. 9 is a partial exploded view of FIG. 8; and

FIG. 10 is a perspective view of FIG. 8.

### DETAILED DESCRIPTION OF THE PREFERRED EMBODIMENTS

Embodiments of the present invention will now be described, by way of example only, with reference to the accompanying drawings.

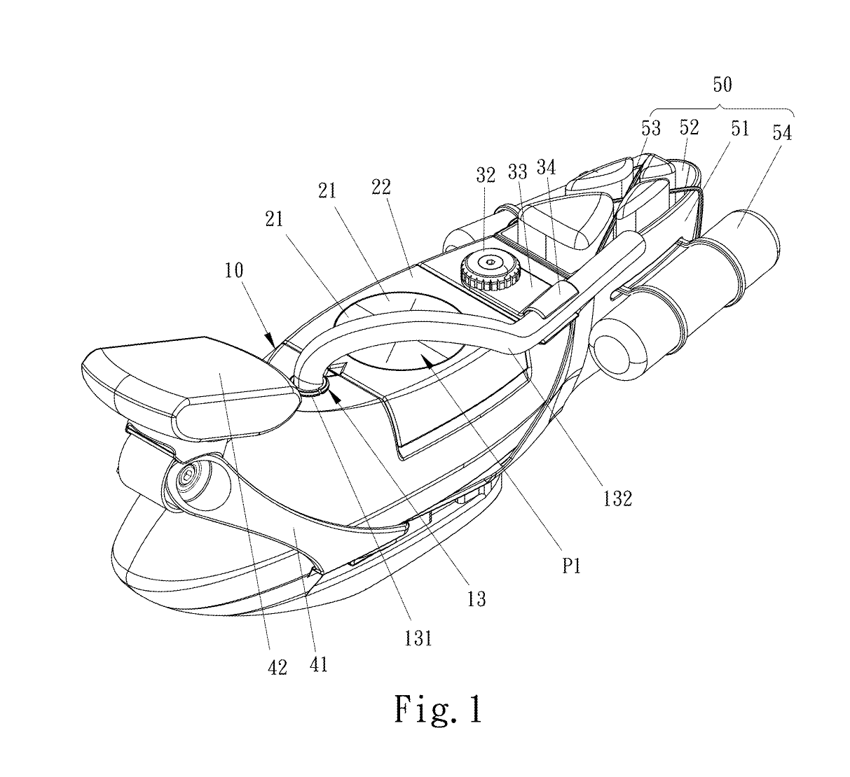

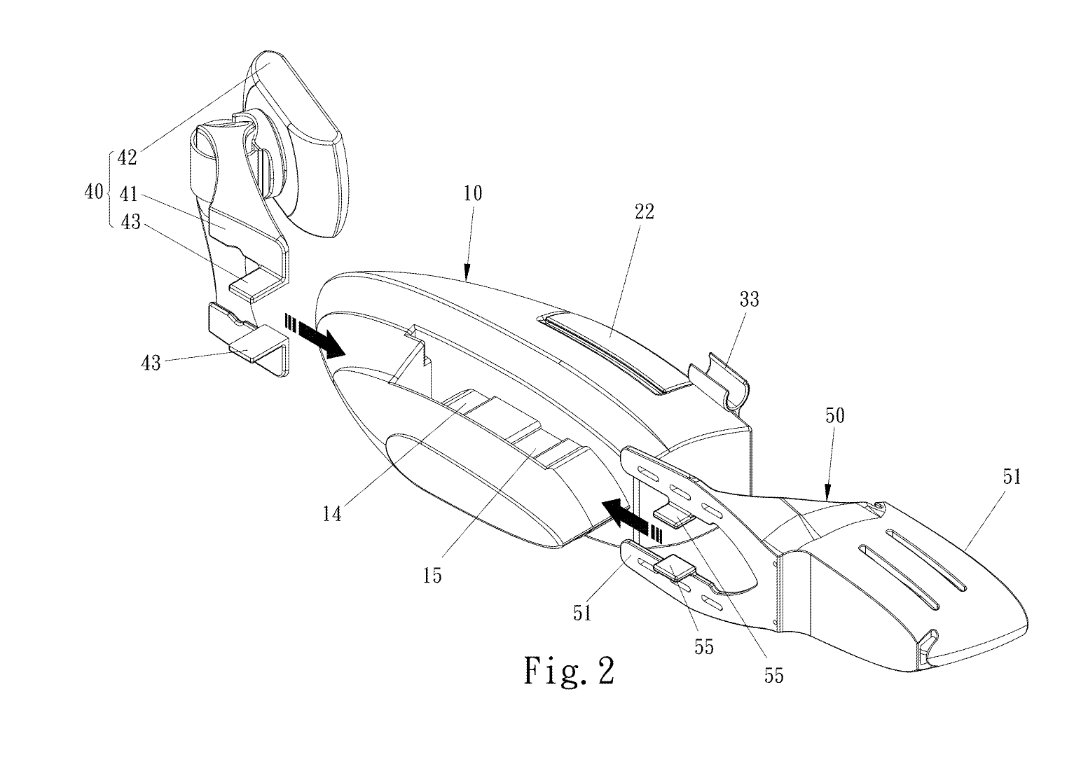

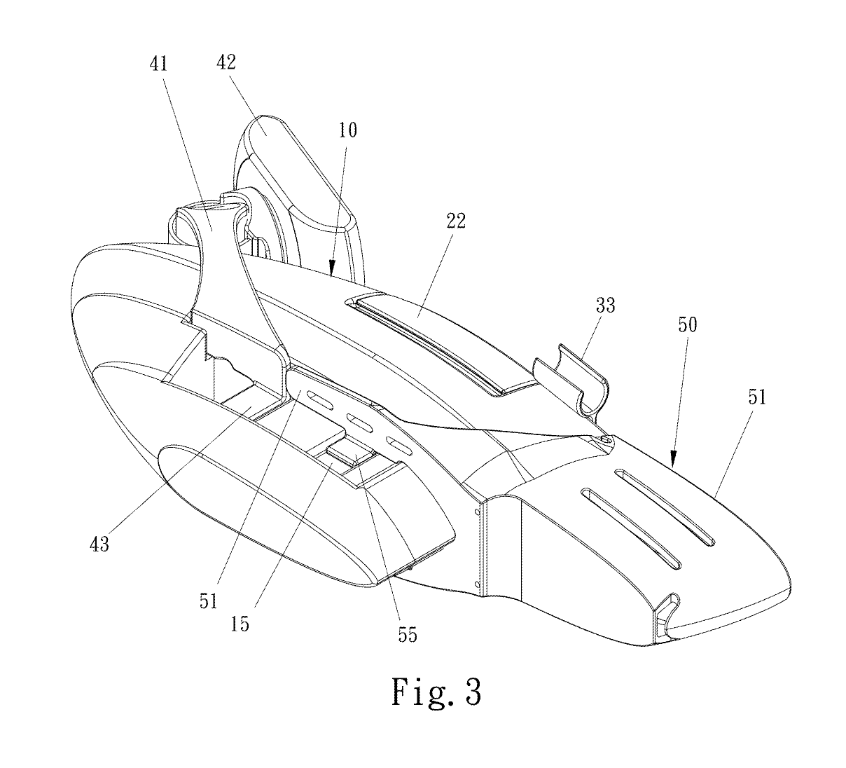

As shown in FIG. 1 to FIG. 10, the present invention discloses a sports water bottle having a pluggable liquid inlet. The sports water bottle comprises a bottle body 10 and a water stopper 20.

The bottle body 10 has an accommodation space 11, a liquid inlet 12, and a liquid outlet 13. The liquid inlet 12 has a wall edge portion 121.

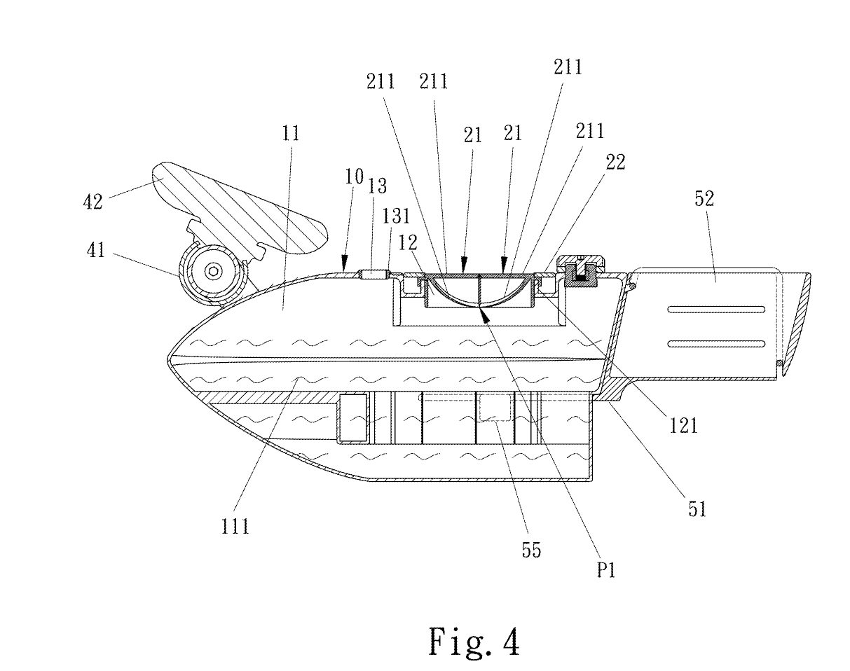

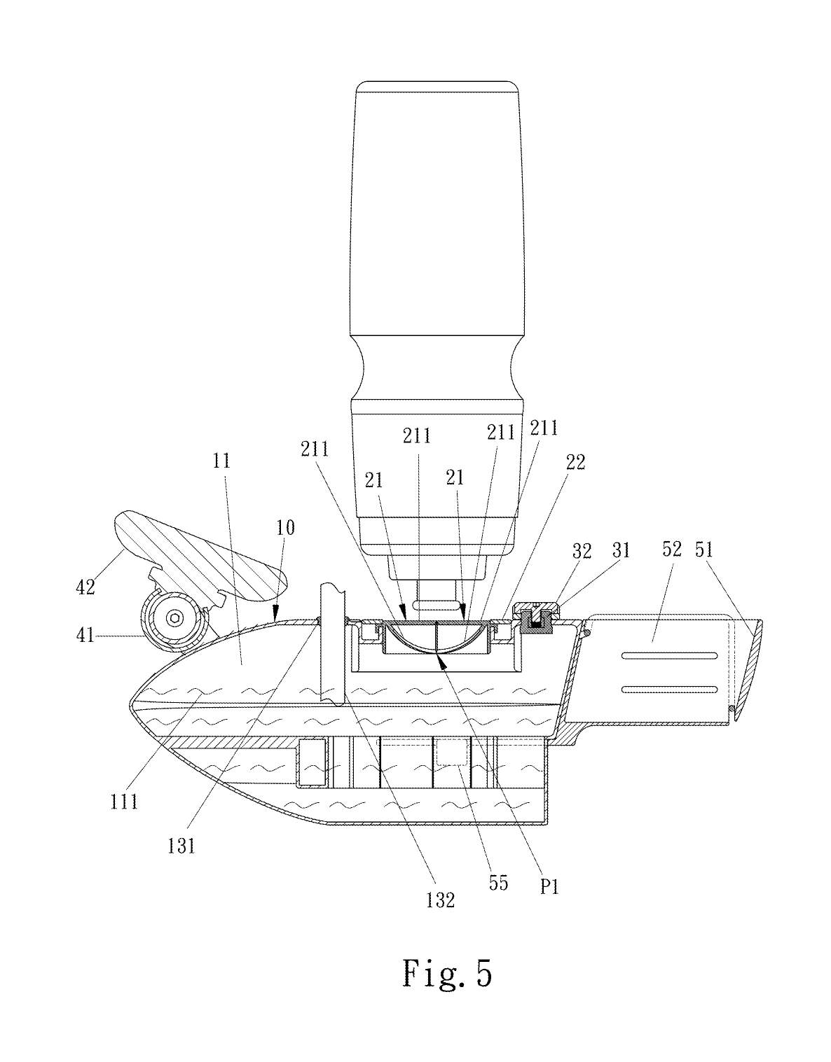

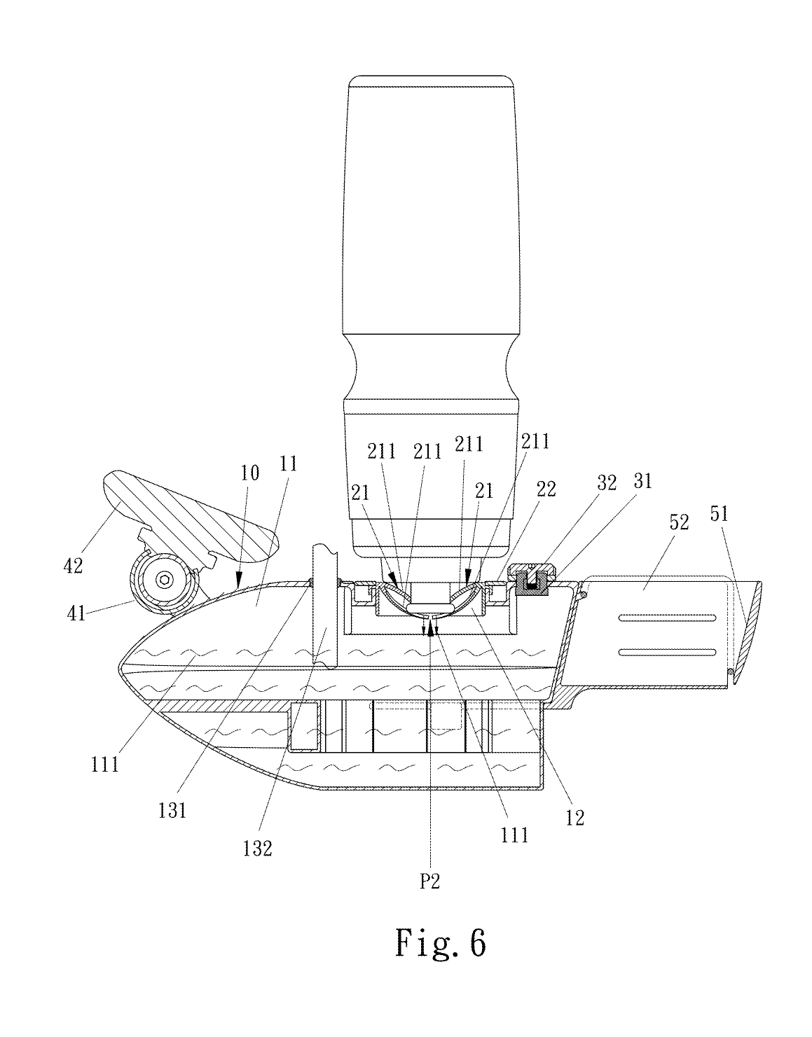

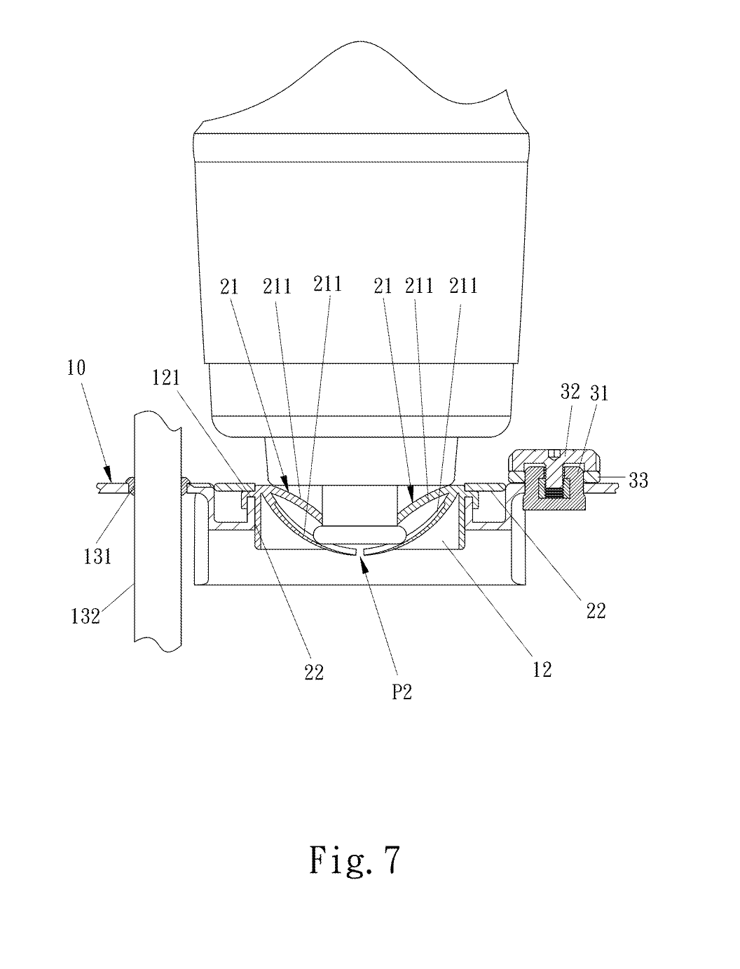

The water stopper 20 is disposed on top of the wall edge portion 121 of the liquid inlet 12, and has a plurality of elastic valves 21 corresponding to the wall edge portion 121. The water stopper 20 has a retraction position P1 (referring to FIG. 4 and FIG. 5) and an expansion position P2 (referring to FIG. 6 and FIG. 7) to open and close the liquid inlet 12, respectively. The water stopper 20 is normally located at the retraction position P1, as shown in FIG. 1.

When the water stopper 20 is applied with an external force (such as the mouth of a water bottle filled with liquid) from the liquid inlet 12 of the bottle body 10 toward the direction of the accommodation space 11 to push the water stopper 20, the water stopper 20 is changed from the retraction position P1 to the expansion position P2 for infusing liquid into the accommodation space 11 through the liquid inlet 12 of the bottle body 10. When not applied with the external force, the water stopper 20 is changed from the expansion position P2 to the retraction position P1.

When in use, the bottle body 10 of the present invention has a streamline shape so the aerodynamic is smooth.

The bottle body 10 can be a water bottle in any shape.

The bottle body 10 comprises a first fixing portion 14 and a second fixing portion 15 at two sides thereof.

The accommodation space 11 of the bottle body 10 is adapted to store drinking liquid.

The liquid outlet 13 of the bottle body 10 is provided with a straw washer 131 for insertion of a straw 132. This is beneficial for the user to drink the liquid quickly.

The water stopper 20 comprises two elastic valves 21 and a retaining cover 22. The retaining cover 22 is fixed on the bottle body 10 to press the water stopper 20, such that the two elastic valves 21 are retained on the wall edge portion 121 of the liquid inlet 12 of the bottle body 10.

The elastic valves 21 of the water stopper 20 can be made of silicone.

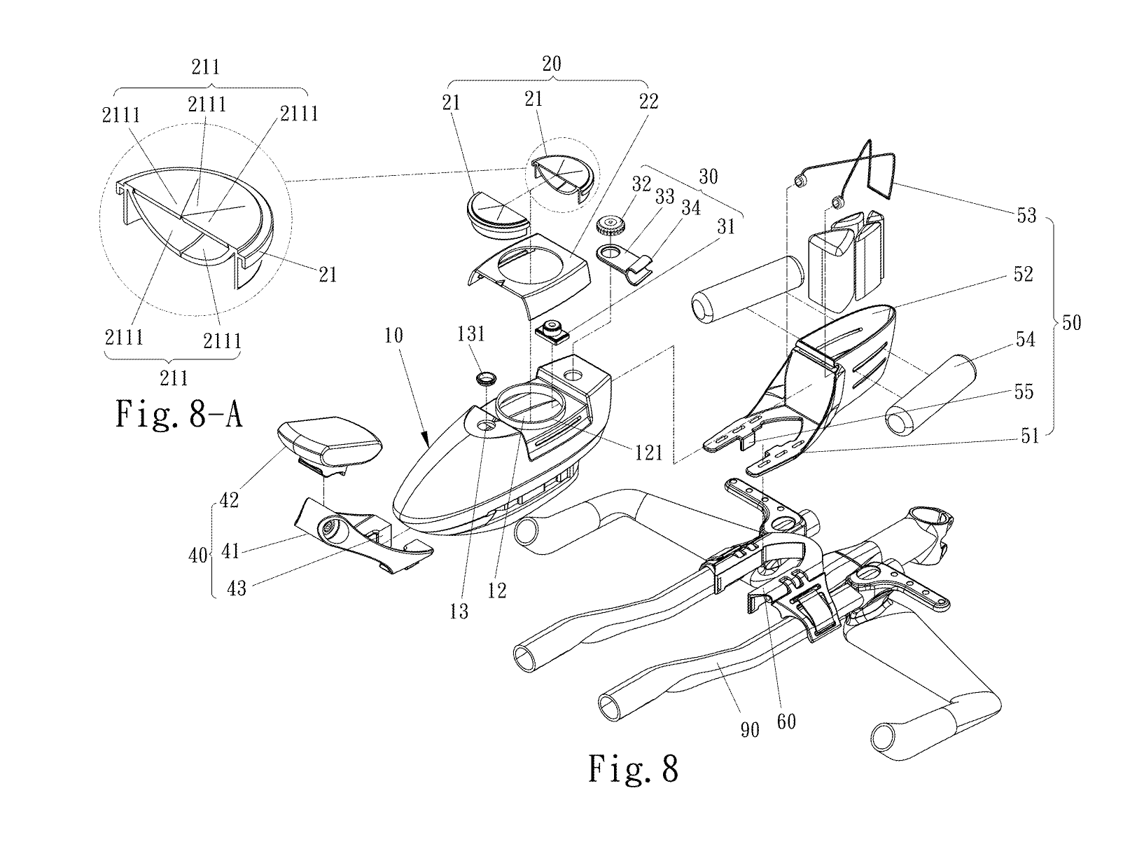

Each elastic valve 21 has two valve membranes 211. Each valve membrane 211 has a plurality of valve pieces 2111, as shown in FIG. 8-A. When the water stopper 20 is applied with an external force from the liquid inlet 12 of the bottle body 10 toward the direction of the accommodation space 11 to push the water stopper 20, the two valve membranes 211 of each elastic valve 21 will be pushed away. The valve pieces 2111 of each valve membrane 211 are opened, such that the water stopper 20 is changed from the retraction position P1 to the expansion position P2 for infusing liquid into the accommodation space 11 through the liquid inlet 12 of the bottle body 10. When the water stopper 20 is not applied with the external force, the valve pieces 2111 are closed and the water stopper 20 is changed from the expansion position P2 to the retraction position P1.

The two valve membranes 211 of each elastic valve 21 are arranged up and down. The upper valve membrane has a flat shape, and the lower valve membrane has a semicircle shape to enhance its retention. The semicircle shape can prevent sagging more than the flat shape. The sagging may form cracks to spill water.

In the embodiment of the present invention, the elastic valves 21 of the water stopper 20 correspond to the liquid inlet 12 of the bottle body 10, and are composed of two semicircles to form a circle. Actually, it can be composed of more than two for covering the liquid inlet 12.

The distance of the upper and lower valve membranes 211 of each elastic valve 21 is especially designed. When water is infused, the mouth of the water bottle (namely, the external force) does not need to be fully inserted, and then the upper and lower valve membranes 211 can be opened.

The water stopper 20 is pressed by the retaining cover 22 for the plurality of elastic valves 21 to be secured on the wall edge portion 121 of the liquid inlet 12 of the bottle body 10, such that the water stopper 20 is flat with the outer surface of the bottle body 10 to reduce the wind resistance.

The present invention further comprises a straw fixing unit 30. The straw fixing unit 30 comprises a locking seat 31, a locking member 32, a frame 33, and a clip 34. The locking member 32 cooperates with the locking seat 31 to lock the frame 33 on the bottle body 10. The frame 33 can be locked at the left or right side of the bottle body 10 for the left-hand or right-hand user. The clip 34 is located at the distal end of the frame 33 for clipping and fixing the straw 132.

The present invention further comprises a stopwatch device 40. The stopwatch device 40 comprises a stopwatch holder 41, a stopwatch 42, and a stopwatch holder connecting portion 43. The stopwatch 42 is disposed on the stopwatch holder 41. The stopwatch holder connecting portion 43 is configured to fix the stopwatch holder 41 to the first fixing portion 14 of the bottle body 10. The number of the stopwatch 42 of the present invention can be one or more. For example, there are two stopwatches to count time for different demands.

The present invention further comprises a storage device 50. The storage device 50 comprises a storage rack 51, a storage space 52, a storage fastener 53, a supplement 54, and a storage connecting portion 55. The storage connecting portion 55 is configured to fix the storage rack 51 to the second fixing portion 15 of the bottle body 10. The storage space 52 is located on the storage rack 51 for accommodating miscellaneous articles, such as towel, medicine, and so on. The storage fastener 53 can be a special elastic rope to prevent the miscellaneous articles from bouncing out. The storage fastener 53 is adapted to fasten the miscellaneous articles in the storage space 52. The supplement 54 can be disposed at two sides of the storage space 52, which can be a salt stick.

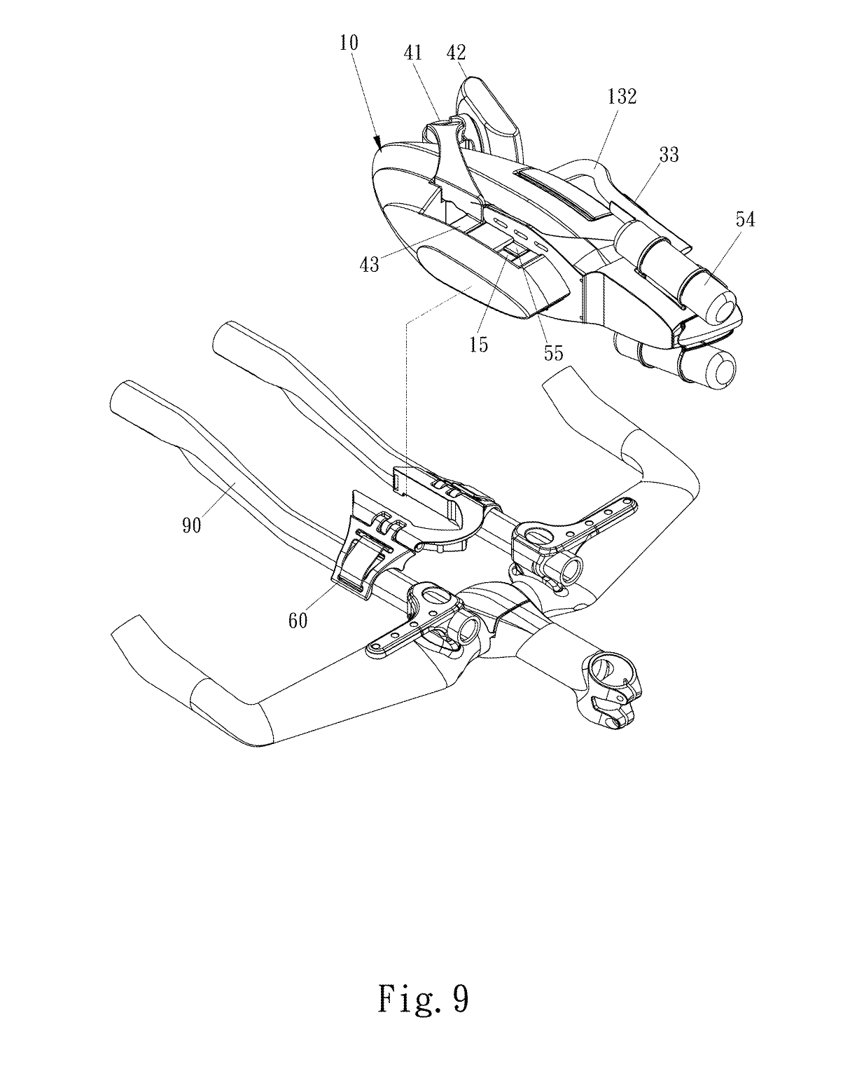

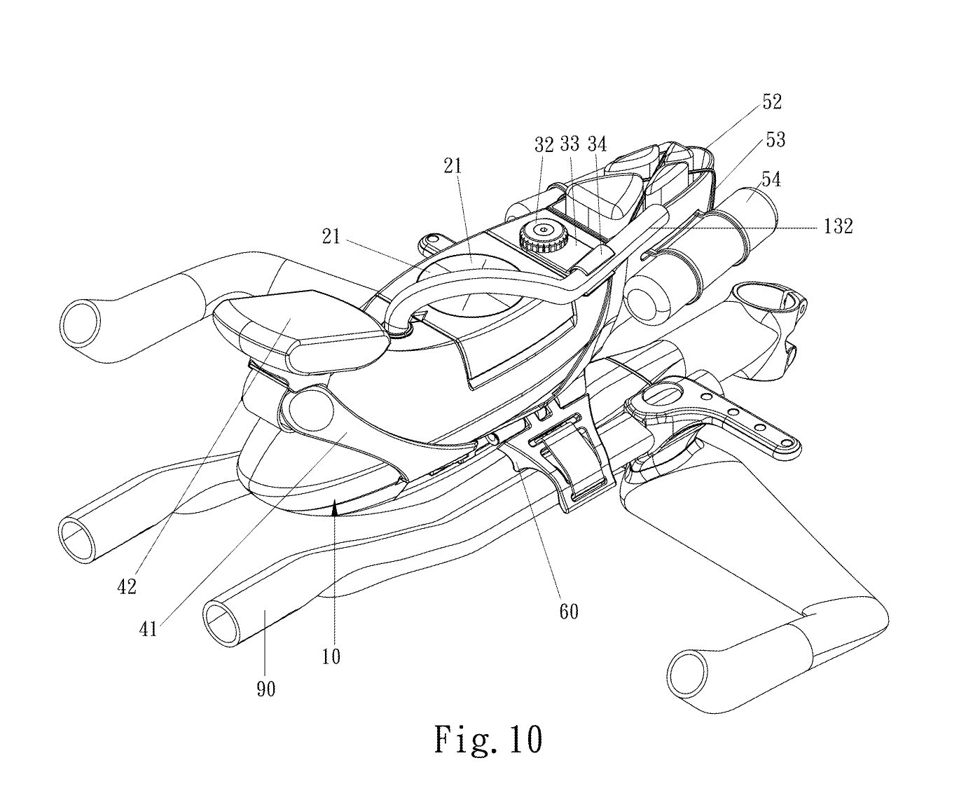

The present invention further comprises a connecting frame 60. The connecting frame 60 is configured to connect the bottle body 10 to a bike handle 90, referring to FIG. 8, FIG. 9 and FIG. 10.

During the use of the present invention, the water stopper 20 is normally located at the retraction position P1. When the mouth of the water bottle is inserted into the water stopper 20 from the liquid inlet 12 toward the direction of the accommodation space 11, the water stopper 20 is changed from the retraction position P1 to the expansion position P2 for infusing the liquid of the water bottle into the accommodation space 11 through the liquid inlet 12 of the bottle body 10. When the water bottle is pulled out, the water stopper 20 is changed from the expansion position P2 to the retraction position P1.

The advantages of the present invention are as follows.

1. The pluggable liquid inlet is beneficial for infusing liquid during riding. The present invention is applied to a bike. When the liquid in the bottle body is used up during riding, the mouth of the water bottle can be inserted into the water stopper quickly for infusing liquid into the bottle body. When the water bottle is pulled out, the water stopper will be closed automatically, without the need to lock or seal again, such that the liquid can be infused quickly during riding.

2. Reducing the probability of water seepage. The two valve membranes of each elastic valve of the water stopper are arranged up and down. The upper valve membrane has a flat shape, and the lower valve membrane has a semicircle shape to enhance its retention. The semicircle shape can prevent sagging more than the flat shape. The sagging may form cracks to spill water.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A sports water bottle, comprising:
a bottle body having an accommodation space, a liquid inlet, and a liquid outlet; and
a water stopper fitted on the liquid inlet of the bottle body, the water stopper having a plurality of elastic valves, each elastic valve having two valve membranes, each valve membrane having a plurality of valve pieces.

2. The sports water bottle as claimed in claim 1, wherein the two valve membranes of each elastic valve are arranged up and down, the upper valve membrane having a flat shape, the lower valve membrane having a semicircle shape.

3. The sports water bottle as claimed in claim 1, wherein the liquid outlet of the bottle body is provided with a straw washer for insertion of a straw.

4. The sports water bottle as claimed in claim 3, further comprising a straw fixing unit, the straw fixing unit comprising a locking seat, a locking member, a frame, and a clip, the clip being located at a distal end of the frame for clipping and fixing the straw.

5. The sports water bottle as claimed in claim 1, further comprising a connecting frame, the connecting frame being configured to connect the bottle body to a bike handle.

6. The sports water bottle as claimed in claim 1, wherein the bottle body comprising a first fixing portion and a second fixing portion at two sides thereof.

7. The sports water bottle as claimed in claim 6, further comprising a stopwatch device, the stopwatch device comprising a stopwatch holder, a stopwatch, and a stopwatch holder connecting portion, the stopwatch being disposed on the stopwatch holder, the stopwatch holder connecting portion being configured to fix the stopwatch holder to the first fixing portion of the bottle body.

8. The sports water bottle as claimed in claim 6, further comprising a storage device, the storage device comprising a storage rack, a storage space, a storage fastener, a supplement, and a storage connecting portion, the storage connecting portion being configured to fix the storage rack to the second fixing portion of the bottle body, the storage space being located on the storage rack for accommodating articles, the storage fastener being adapted to fasten the articles in the storage space.

9. The sports water bottle as claimed in claim 8, wherein the supplement of the storage device is disposed at two sides of the storage space, the supplement being a salt stick.
